(19) United States
(12) Patent Application Publication
(10) Pub. No.: US 2010/0045473 A1
(43) Pub. Date: Feb. 25, 2010

(54) NON-METALLIC ALERT SYSTEMS

(75) Inventor: Donald E. Frizzell, Birmingham, AL (US)

Correspondence Address: TROUTMAN SANDERS LLP;BANK OF AMERICA PLAZA, 600 PEACHTREE STREET, N.E., SUITE 5200, ATLANTA, GA, 30308-2216, US

(73) Assignee: The Southern Company, Atlanta, GA (US)

(21) Appl. No.: 12/543,266

(22) Filed: Aug. 18, 2009

Related U.S. Application Data
(60) Provisional application No. 61/090,395, filed on Aug. 20, 2008.

(51) Int. Cl. G08B 21/02

(52) U.S. Cl. 340/649

(57) ABSTRACT

Alert systems indicate removal of one or more protected portions of electrical grounding assemblies. An alert system can include a signal transmitter, a signal receiver, an alert device, and a communication cable. The signal transmitter can transmit a signal to be received by the signal receiver. The alert device can be coupled to the signal receiver, such that the alert device is activated when the signal is not received. A non-metallic communication cable can propagate the signal from the signal transmitter to signal receiver. The communication cable can be bound to a protected portion of the grounding assembly, such that disturbance of the protected portion can damage the communication cable. Because damage to the communication cable can cause an interruption in the signal, such damage can result in activation of the alert device. Accordingly, disturbance of the protected portion of the grounding assembly can activate the alert device.

### CROSS-REFERENCE TO RELATED APPLICATIONS

This application claims the benefit, under 35 U.S.C. § 119(e), of U.S. Provisional Application Ser. No. 61/090,395, filed 20 Aug. 2008, the entire contents and substance of which is hereby incorporated by reference.

### BACKGROUND

Various aspects of the present invention relate to alert systems and, moreover, to alert systems utilizing non-metallic cables for alerting to the removal of a portion of an electrical grounding assembly.

Electrical equipment in and around a building should be grounded to provide protection to people and objects in and around the building from damage that can be caused by electrical surges, for example, from lightening strikes. A grounding system for a stationary structure, such as a non-residential building, generally includes grounding wires, one or more interior master ground bars, an exterior master ground bar, a down ground, and a grounding ring.

The grounding wires are included as part of the electrical equipment inside the building. The grounding system connects the grounding wires to a physical ground, such as the earth. Connecting the grounding wires to a physical ground tends to limit voltage building up between the electrical equipment and the physical ground. As a result, the equipment and those in proximity to the equipment are, to some degree, protected from electrical shock.

Grounding wires from equipment inside the building come to a junction at an interior master ground bar, which is commonly located in the interior of the building. The interior master ground bar is in communication with the exterior master ground bar on the exterior of the building. The down ground, or down run, extends from the exterior master ground bar to the grounding ring, thereby connecting the exterior master ground bar to the grounding ring. The grounding ring creates a closed, underground loop around the building. It is desirable that the grounding ring be buried beneath the frost line to avoid any significant change in resistance when the ground freezes.

The building, being a first stationary structure, may be in communication with a second stationary structure, such as a tower. In that case, the second stationary structure can also include a grounding system. The building can be in communication with the tower in many ways. For example, the tower can be a cellular tower operated by people and equipment in the building.

The tower's grounding system also generally includes grounding wires for internal electronic equipment, one or more interior master ground bars, an exterior master ground bar, a down ground, and a grounding ring. The tower and building grounding rings can be connected together, ensuring that there is no difference in electric potential between the tower grounding ring and the building grounding ring.

Generally, components of the grounding system are composed of copper, copper clad steel, or some other conductive material. Because copper is valuable, thieves sometimes cut portions of the grounding systems and remove portions of copper cabling, particularly the exterior master ground bar or the down ground. If such removal goes undetected or unrepaired, the building remains ungrounded and, therefore, unprotected from lightning strikes. As a result, a lightning strike can cause great damage or injury to equipment and occupants of the building or tower.

Monitoring mechanisms for detecting removal of copper cabling are problematic because such mechanisms conventionally consist of additional metallic wiring. While metallic wiring can assist in detecting removal of a portion of the grounding system, metallic wiring can also route electricity caused by a lightning strike from the unprotected building to a monitoring site, causing a dangerous condition for people or equipment monitoring the grounding system. Alternatively, human monitors can affirmatively check the grounding system to ensure that the cabling remains uninterrupted. This conventionally requires either a visual confirmation or measuring resistance of the system via a megger. Such checks can be both time-consuming and expensive.

### SUMMARY

There is a need for an alert system capable of indicating when a portion or element of an electrical grounding system has been removed. Additionally, in an exemplary embodiment, such an alert system can be apparent to potential thieves, so as to discourage disturbance of the grounding system. It is to such an alert system that embodiments of the present invention are directed.

Briefly described, various aspects of the alert system include an alert system for indicating the removal of a master ground bar or other protected portion of an electrical grounding system. The alert system can comprise a signal transmitter, a signal receiver, an alert device, and a non-metallic communication cable.

The signal transmitter can provide a signal, and the signal receiver can receive the provided signal.

The alert device can be various devices or mechanisms for alerting to the removal of a protected portion of the grounding assembly. For example and not limitation, the alert device can be an alarm or one or more floodlights. The alert device can be coupled to the signal receiver, such that an interruption of the signal activates the alert device. In some embodiments, the alert device can be coupled to the receiver through a relay. The relay can remain de-energized while the receiver receives a signal from the signal transmitter. The signal can be either a continuous signal, such as a continuous wave signal, or a pulsed signal having a predetermined frequency. If the receiver fails to receive the signal, the relay can become energized and can, thereby, activate the alert device.

The non-metallic communication cable can connect the signal transmitter to the signal receiver, and can propagate the signal from the signal transmitter to the receiver. In an exemplary embodiment, the communication cable can be a fiber optic cable, and the signal can be a light signal.

The communication cable can be securely bound to a protected portion, or protected component, of the grounding system. For example, the communication cable to be bound to an external master ground bar or to a down ground. Binding of the communication cable to the protected component can occur in various manners. For example, a master ground bar can have plurality of apertures, some of which are generally used to secure the master ground bar in position within the grounding assembly. The communication cable can be threaded through one or more of the apertures. Alternatively, or additionally, the communication cable can be adhered to the master ground bar. The communication cable can be securely bound to the protected component, such that removal of the protected component from the grounding assembly severs, or otherwise damages, the communication cable.

In operation, when the protected component of the grounding system is removed, the signal propagating through the communication cable is interrupted, thereby energizing the relay and powering the alert device.

These and other objects, features, and advantages of the alert system will become more apparent upon reading the following specification in conjunction with the accompanying drawing figures.

### BRIEF DESCRIPTION OF THE FIGURES

FIG. 1 illustrates a conventional grounding system of a non-residential structure.

FIG. 2 illustrates a diagram of an alert system, according to an exemplary embodiment of the present invention.

FIG. 3 illustrates a diagram of attachment of a non-metallic communication cable of the alert system to a master ground bar of a grounding assembly, according to an exemplary embodiment of the present invention.

FIG. 4 illustrates a perspective view of a master ground bar protected by the alert system, according to an exemplary embodiment of the present invention.

FIG. 5 illustrates a schematic of the alert system, according to an exemplary embodiment of the present invention.

FIG. 6 illustrates a schematic of an alternative embodiment of the alert system, according to an exemplary embodiment of the present invention.

### DETAILED DESCRIPTION

To facilitate an understanding of the principles and features of the invention, various illustrative embodiments are explained below. In particular, the invention is described in the context of being a non-metallic based alert system for indicating removal of a protected portion of a grounding system. Embodiments of the invention, however, are not limited to monitoring grounding systems, but can be used as alert systems in many environments and for many purposes.

The components described hereinafter as making up various elements of the alert system are intended to be illustrative and not restrictive. Many suitable components that would perform the same or similar functions as the components described herein are intended to be embraced within the scope of the invention. Such other components not described herein can include, but are not limited to, for example, components that are developed after development of the invention.

Various embodiments of the present invention comprise alert systems. Exemplary embodiments of an alert system can comprise a signal transmitter, a signal receiver, an alert device, and a non-metallic communication cable.

Referring now to the figures, wherein like reference numerals represent like parts throughout the views, embodiments of the alert system will be described in detail.

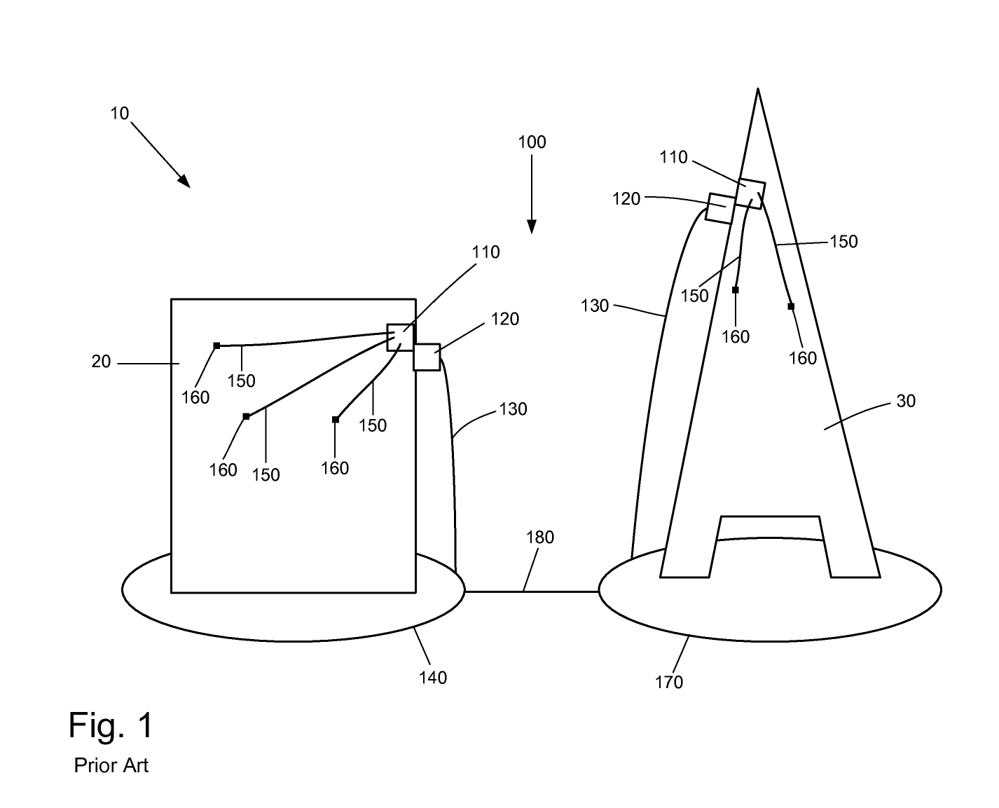

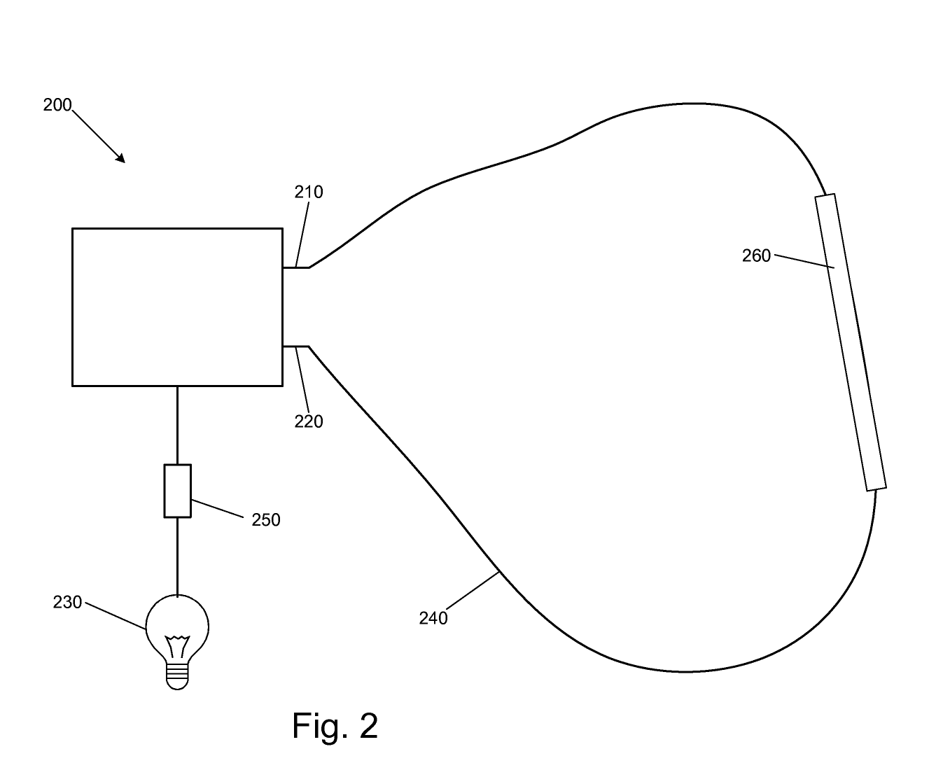

FIG. 1 illustrates a conventional grounding system 100, or grounding assembly, of an exemplary non-residential structural group 10. Grounding systems such as that depicted in FIG. 1 can be monitored by embodiments of the alert system 200 (see FIG. 2). The structural group can comprise one or more of a building 20 and a tower 30. The grounding system 100 utilized in the structural group can comprise one or more interior master ground bars 110, an exterior master ground bar 120, a down ground 130, and a building grounding ring 140. Embodiments of the alert system 200 represent an improvement to conventional grounding systems 100. As such, embodiments of the alert system 200 can be retrofitted to preexisting grounding systems 100, or can be installed when new building structures are erected.

One or more grounding wires 150 of an equipment assembly 160 in the building 20 can connect to the interior master ground bar 110. In typical designs of the grounding system 100, the interior master ground bar 110 can connect to the exterior master ground bar 120, and the exterior master ground bar 120 can ultimately connect to the building grounding ring 140 by way of the down ground 130. According to the National Electrical Code, the building grounding ring 140 should be buried below the frost line or no less than 18 inches beneath the ground's surface. The building grounding ring 140 can surround the building 20 as shown. One or more components of the grounding system 100 can be composed, in full or in part, of copper or many other conductive materials.

In an exemplary embodiment, the building 20 can be in communication with another structure, such as a tower 30. For example and not limitation, the tower 30 can be a cellular tower, for which equipment and occupants of the building 20 provide operations assistance. The electrical equipment assembly 160 in or around the tower 30 can connect to the interior tower master ground bar 110 via grounding wires 150, and the interior tower master ground bar 110 can connect to the exterior tower master ground bar 120. The exterior tower master ground bar 120 can be connected to a tower grounding ring 170 by way of the down ground 130. Like the building grounding ring 140, the tower grounding ring 170 should be buried below the frost line or no less than 18 inches beneath the ground's surface. In some embodiments, to ensure that there is no difference in electrical potential between the building grounding ring 140 and the tower grounding ring 170, the grounding rings 140 and 170 can be connected by wiring 180, as shown in FIG. 1.

A dangerous condition can occur for equipment and occupants of the structural group 10 if a portion of the grounding system 100 is removed. If the equipment assembly 160 in or in proximity to the building 20 or the tower 30 is not properly grounded, such equipment assembly 160 is more susceptible to electrical shock, which can damage equipment and endanger humans. For example, if elements of the grounding system 100 are removed, e.g., by theft, a lightning strike or other power surge could damage not only equipment in and around the previously grounded structure, but also anyone in or nearby the structure. Accordingly, embodiments of the alert system 200 can be configured to provide an alert when removal of one or more protected portions of the grounding system 100 occurs.

FIG. 2 illustrates a diagram of an exemplary embodiment of the alert system 200. The alert system 200 can monitor the grounding system 100 and provide an alert when a protected portion of the grounding system 100 is removed from the grounding system 100. As shown in FIG. 2, the alert system 200 can comprise a signal transmitter 210, a signal receiver 220, an alert device 230, and at least one communication cable 240.

The signal transmitter 210 can provide a signal for propagation to the signal receiver 220. In an exemplary embodiment of the alert system 200, the signal transmitter 210 can provide a signal that is transmittable across a non-metallic cable. For example and not limitation, the signal transmitter 210 can provide an optical fiber signal, or a light signal, for propagation through a fiber optic cable. In an exemplary embodiment, the signal provided by the signal transmitter 210 can be a continuous signal, such as a continuous wave signal. Alternatively, however, a pulse signal or other signal having a consistent pattern can be provided.

The signal receiver 220 can receive the signal and, accordingly, can detect whether the signal is successfully transmitted from the signal transmitter 210 to the signal receiver 220.

The alert device 230 can comprise various devices or mechanisms, audible or inaudible, for alerting to the removal of a protected portion of the grounding system 100. For example and not limitation, the alert device 230 can comprise a flashing light, a beeping or other audible alarm, or a vibration. Alternatively, or additionally, the alert device 230 can route a notification of the removal to a remote monitoring site. The alert device 230 can be in communication with the signal receiver 220, such that an interruption of the signal activates the alert device 230. For example, the alert device 230 can be coupled to the receiver 220 through a relay 250. The relay 250 can remain de-energized while the receiver 220 receives a continuous wave signal, or otherwise consistent signal, from the signal transmitter 210. If the receiver 220 fails to receive the signal, or detects an interruption in the signal, the relay 250 can become energized, thereby powering the alert device 230.

The communication cable 240 can connect the signal transmitter 210 to the signal receiver 220, and can propagate the signal from the signal transmitter 210 to the receiver 220. The communication cable 240 can be a single component, or can comprise a series of units, such as multiple smaller cables connected together to act as a single cable.

The communication cable 240 can be composed of one or more non-metallic materials. Metal cabling could cause a lightning strike to the tower 30 to be routed to the building 20 or other monitoring site, or vice versa, where resulting electricity could cause further damage and injury. Accordingly, it is desirable that the communication cable 240 be formed from materials with little conductivity. For example and not limitation, a multimode fiber optic cable can be used as the communication cable 240. In that case, the signal propagated through the communication cable 240 can be a light signal transmitted by the signal transmitter 210.

The communication cable 240 can be bound to a protected portion 260, or protected component, of the grounding system. For example, the communication cable 240 to be bound to an external master ground bar 120 or to a down ground 130. The communication cable 240 can be securely attached to the protected portion 260 of the grounding system 100, such that removal of the protected portion from the grounding system 100 severs, or otherwise damages, the communication cable 240.

In operation, when the protected portion 260 of the grounding system 100 is removed or sufficiently disturbed, the communication cable 240 can be damaged. As a result, the signal propagating through the communication cable 240 can be interrupted, thereby energizing the relay 250 and powering the alert device 230. Accordingly, the alert system 200 can produce an alert when the protected portion 260 of the grounding system 100 is severed, removed, or otherwise disrupted.

Additionally, although not shown in FIG. 2, an optional time delay relay, or second relay, can be in communication with the first relay 250 and the alert device 230. When the first relay 250 is activated, the first relay 250 can activate the time delay relay. The time delay relay can restrict the time during which the alert device 230 is active. For example, the time delay relay can cause the alert device 230 to continue its alert function for a limited time period, such as a few minutes.

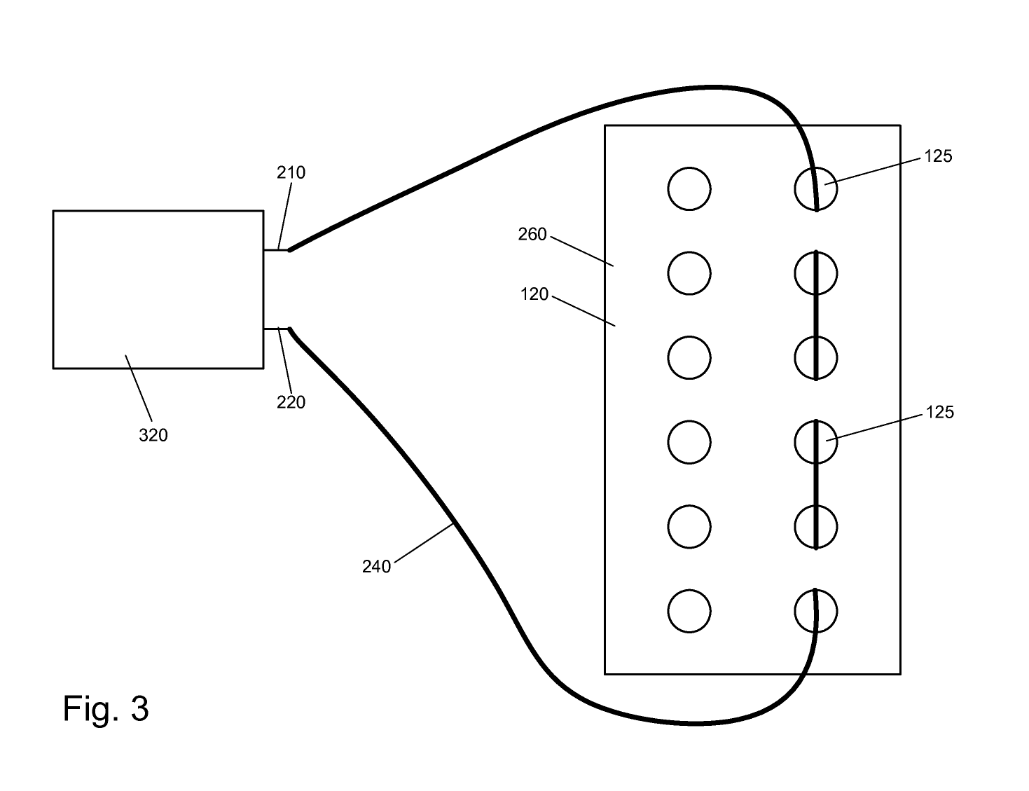

FIG. 3 illustrates a manner of binding the communication cable 240 to the protected portion 260 of the grounding system 100. As shown in FIG. 3, the protected portion 260 can be a master ground bar 120, or a portion thereof. Alternatively, however, the protected portion 260 can be a down ground 130 or other portion of the grounding system 100.

As depicted in FIG. 3, the communication cable 240 can be in physical communication with the master ground bar 120 or other protected portion 260 of the grounding system 100. More specifically, in an exemplary embodiment of the alert system 200, the communication cable 240 can be so securely attached to the master ground bar 120 that removal of the master ground bar 120 can damage the communication cable 240 to such a degree as to interrupt the signal propagating through the communication cable 240. In an exemplary embodiment, the communication cable 240 can be adhered to a portion of the grounding system 100 with Tanglefoot adhesive.

The communication cable 240 can be bound, or attached to, the protected portion 260 of the grounding system 100 by many means, so long as removing the communication cable 240 from the protected portions would be difficult, if not impossible, to achieve without at least partially severing or damaging the communication cable 240.

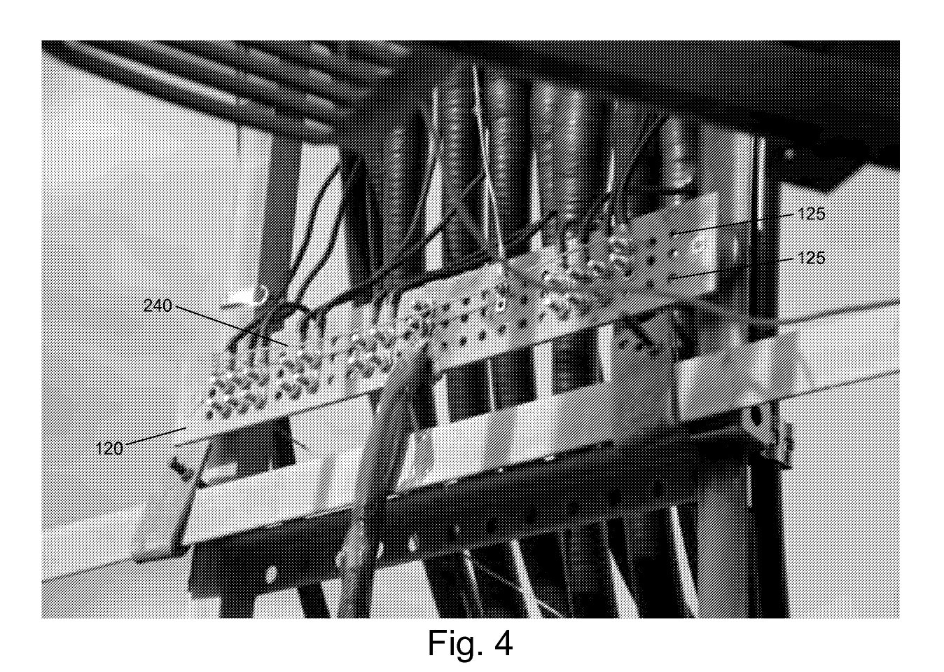

Binding of the communication cable 240 to the protected component can occur in various manners. For example, a master ground bar 120 can define a plurality of apertures 125, some of which are generally used to secure the master ground bar 120 in position within the grounding system 100. The communication cable 240 can be threaded through one or more of the apertures 125. FIG. 4 illustrates a perspective view of the alert system 200, in which the communication cable 240 is threaded through apertures 125 in the master ground bar 120. Alternatively, or additionally, the communication cable 240 can be adhered to the protected portion 260 of the grounding system 100 at one or multiple points, wrapped around the protected portion 260, or otherwise attached to the protected portion 260.

Consequently, if a portion of the exterior master ground bar 120 is removed from the grounding system 100, the communication cable 240 will likely be broken, severed, or sufficiently bent to disrupt a signal transmitted through the communication cable 240. Such disturbance of the communication cable 240 can disrupt the signal, thereby triggering the relay 250 to activate the alert device 230.

Various specific components can be utilized to implement the alert system 200. For example and not limitation, the signal transmitter 210 and the signal receiver 220 can be separate devices or can be integrated into a single black box device.

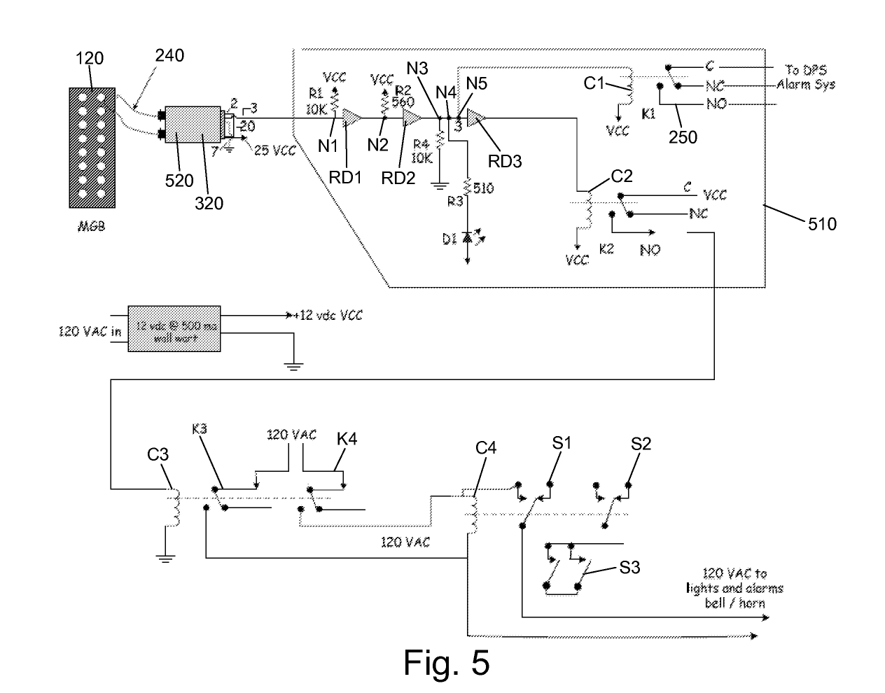

FIG. 5 illustrates a schematic of an exemplary embodiment of the alert system. An RS-232 to fiber converter 320 (see FIG. 3), which converts serial binary data signals to optical fiber signals, such as the Cooper PN KME4-163 510 depicted in FIG. 5, can be used as the black box device including the signal transmitter 210 and the signal receiver 220. The fiber converter 320 can produce a continuous signal. As a result, the signal receiver 220 may be high when the fiber optic communication cable 240 remains undisrupted, and low when the communication cable 240 is disconnected. Accordingly, a low output from the receiver 220 indicates that the communication cable 240 is disconnected. Accordingly, a low output can indicate a potential problem with the protected portion 260 of the grounding system 100.

When the signal generated by the signal transmitter 210 is interrupted, the first relay 250 can activate the alert device 230. Many available or newly developed components can be used as the first relay 250. For example and not limitation, the first relay 250 can comprise a ULN2003A high current/high voltage relay, which is compatible with the Cooper converter 520.

The schematic of FIG. 5 depicts various other components related to an exemplary embodiment of the alert system 200, including the signal transmitter 210, the signal receiver 220, the communication cable 240, the master ground bar 120, the alert device 230, and a relay assembly 510.

As shown in FIG. 5, the signal transmitter 210 and the signal receiver 220 can be provided in a single black box device 320, in this case, the Cooper converter 520. The converter 520 can be coupled to a ground, and adapted to create the signal transmitter 210 for producing a continuous wave signal. In an exemplary embodiment, the signal can be approximately 25 volts.

The communication cable 240 can be coupled to the signal transmitter 210 at one end and the signal receiver 220 at another end. Between these two ends, the communication cable 240 can be bound to the master ground bar 120 or other protected portion of a grounding system 100. Accordingly, when the master ground bar 120 is removed, the communication cable 240 can be damaged, such that the signal receiver 220 does not receive the signal transmitted by the signal transmitter 210.

An output of the Cooper converter 520 can be coupled to a first node N1 within the relay assembly 510. The relay assembly 510 can comprise a collection of nodes, relay drivers, relays, and other components for activating and directing the alert device 230 as desired. The first node N1 can be coupled to a relay driver RD1, which can be, for example, a ULN2003A relay driver. The first node N1 can also be tied to a voltage by way of a resister R1. In some embodiments, the resister R1 can have a resistance of approximately 10 kΩ. An output of the resister R1 can be coupled to a second node N2. The second node N2 can be tied to a voltage by way of a resistor R2. The resister R2 can have a resistance of approximately 560Ω. The second node N2 can also be coupled to a second relay driver RD2. An output of the second relay driver RD2 can be coupled to a third node N3, which can be coupled to a ground through use of another resister R4. The resister R4 can have a resistance of approximately 10 kΩ. The third node N3 can also be coupled to a fourth node N4. The fourth node N4 can be tied to a diode D1 by way of a resister R3, which can have a resistance of approximately 510Ω. The fourth node N4 can be coupled to a fifth node N5. The fifth node N5 can be tied to a voltage through a relay coil C1. The relay coil C1 can be coupled to a first relay K1, which can energize the alert device 230 as discussed above. The first relay K1 can be equivalent to the first relay 250, which, as discussed above, can be energized when the signal receiver 220 fails to receive the signal. The fifth node N5 can be coupled to third relay driver RD3. The output of the third relay driver RD3 can be coupled to a second relay coil C2, which can be coupled to a voltage. The second relay coil C2 can also be coupled to a second relay K2, which can direct one or more limitations regarding the duration and type of alert emitted by the alert system 200. In an exemplary embodiment, the first and second relays 250 and K2 can each be an Aromat 12 vdc relay PN JS1-12V having coil resistance of approximately 400 ohms.

The second relay K2 can be coupled to a third relay coil C3, which can be tied to a ground. The third relay coil C3 can be coupled to a third relay K3. In an exemplary embodiment, the third relay K3 can be an Omron MK2P-S relay. The third relay K3 can be coupled to a fourth relay K4 and an output directed to various alert mechanisms. In an exemplary embodiment, the fourth relay K4 can be a TYCO TDR 120 VAC COIL PN CNT-35-96 C1 TDR time-delay relay. The fourth relay K4 can be coupled to a fourth relay coil C4. The fourth relay coil C4 can be coupled to a first switch S1 and an output directed to various alert mechanisms. The first switch S1 can be coupled to a second switch S2, which can be coupled to a third switch S3.

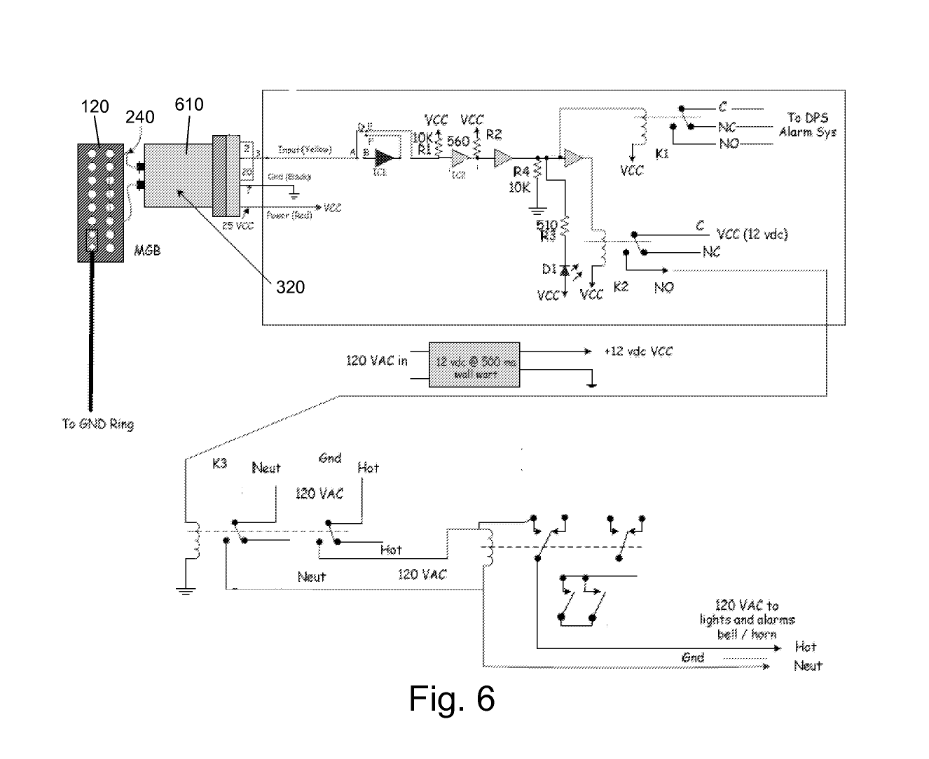

FIG. 6 illustrates a schematic of an alternative exemplary embodiment of the alert system 200. The embodiment of FIG. 6 can utilize a Model ME610E converter 610 or, via program jumpers, the Cooper converter 520. The remainder of the components and connections in the alert system 200 can be modified, as shown in FIG. 6 or in another manner, from the FIG. 5 schematic to better cooperate with the Model ME610E converter 610 or the Cooper converter 520.

In addition to monitoring grounding system 100, various embodiments of the alert system 200 can be used for various other applications. For example and not limitation, an exemplary embodiment of the alert system 200 can be utilized to monitor a fire alarm associated with a scrubber in a control center. The monitoring can take place from a remote plant. In some cases, the monitoring plant may need to be distinct and electrically isolated from the control center. Consequently, use of metallic wiring between the plant and the control center may be impermissible.

An embodiment of the alert system 200 can be utilized to monitor a fire alarm contact in the control center. Such an embodiment can include a fiber converter 320 at the fire alarm contact. The fire alarm contact can furnish direct current power to the fiber converter 320, and a battery backup can be included for increased reliability of the system 200.

In an exemplary embodiment of the alert system utilizing the fiber converter 320 to monitor the fire alarm contact, the fire alarm contact can feed power into the converter 320. As in some other exemplary embodiments of the alert system 200, the signal transmitter 210 portion of the fiber converter 320 can transmit a signal to the signal receiver 220 portion. When the fire alarm at the scrubber detects a fire, the contacts on the alarm pane can open automatically. Opening of the contacts can cause a loss of power at the converter 320, which can cause the signal transmitter 210 to fail. Accordingly, the alert device 230 can activate when the fire alarm detects a fire.

Another exemplary embodiment of the alert system 200 can be used to monitor a DC charger pole mounted charger. Such a charger may be used to charge batteries and to run a RHL fiber converter. In some instances, a loss of current to the charger may occur, or the charger may fail. As a result, the batteries can run down, causing a communication failure. Accordingly, embodiments of the alert system 200 can be used to monitor the charger's DC voltage without undesirable feedback from the batteries.

An embodiment of the alert system 200 can be configured to solve the above problem. A DC-to-DC converter can convert the charger's output to enable the output to power the converter 320. For example, the DC-to-DC converter can convert the charger's output to +12 vdc for powering the converter 320. The alert system 200 can further include a blocking diode rated at the charger's max output, e.g., 12-15 amps, to prevent or reduce back feed of the batteries to the converter 320. When the charger drops out, the DC-to-DC output can drop to zero volts, which can cause power to be lost at the converter 320. As a result, the signal transmitter 210 can fail to transmit, and the signal receiver 220 can fail to detect a signal. Accordingly, the alert device 230 can be activated in response to the charger drop-out.

Accordingly, as described above, exemplary embodiments of the alert system 200 can monitor one or more protected portions of grounding systems 100 or various other systems, and can provide alerts when such protected portions have undesirable characteristics.

While the alert system 200 has been disclosed in exemplary forms, it will be apparent to those skilled in the art that many modifications, additions, and deletions can be made without departing from the spirit and scope of the alert system and its equivalents, as set forth in the following claims.

What is claimed is:

1. An alert system for alerting to a disturbance of a protected component, the system comprising:
a signal transmitter for providing a signal;
a receiver for receiving the signal;
a relay coupled to receiver, and being triggered when the receiver does not receive the signal;
a non-metallic communication cable for propagating the signal from the signal transmitter to the receiver, the non-metallic communication cable being attached to a protected section of the protected component, wherein removal of the protected section damages the non-metallic communication cable and causes an interruption in the signal, and wherein the relay is triggered in response to the signal interruption; and
an alert device activated in response to the relay being triggered.

2. The alert system of claim 1, the non-metallic communication cable being a fiber optic cable, and the signal being a light signal.

3. The alert system of claim 1, the protected component being a portion of a grounding assembly for a structure.

4. The alert system of claim 1, the non-metallic communication cable being adhered to the protected section of the protected component.

5. The alert system of claim 1, the non-metallic communication cable being threaded through one or more apertures in the protected section of the protected component.

6. The alert system of claim 1, the alert device emitting an audible alarm.

7. The alert system of claim 1, the alert device transmitting an inaudible signal to a remote location.

8. The alert system of claim 1, the alert device displaying a visible alert.

9. The alert system of claim 1, further comprising a time-delay relay configured to limit the time during which the alert device is activated.

10. An alert system comprising:
a circuit comprising:
a signal transmitter for transmitting a signal;
a receiver for receiving the signal;
a non-metallic communication cable for conveying the signal from the signal transmitter to the relay;
a relay remaining de-energized while the receiver receives the signal; and
an alert device powerable by the relay when the relay is energized;
wherein the non-metallic communication cable of the circuit is bound to a protected portion of a grounding assembly, and removal of the protected portion damages the non-metallic communication cable, thereby interrupting the signal.

11. The alert system of claim 10, the protected portion of the grounding assembly being a master ground bar.

12. The alert system of claim 10, the protected portion of the grounding assembly defining one or more apertures through which the non-metallic communication cable is threaded.

13. The alert system of claim 10, the non-metallic communication cable being wrapped around the protected portion of the grounding assembly.

14. The alert system of claim 10, wherein the signal transmitter and the signal receiver of the circuit are components of a single black box device.

15. The alert system of claim 10, the signal being a continuous signal.

16. The alert system of claim 10, the signal being a pulse signal.

17. An alert system for alerting to removal of a protected component of a grounding assembly, the system comprising:
a black box device comprising:
an output pin for transmitting a signal; and
an input pin for receiving the signal;
a relay couplable to the black box device, and energizable when the input pin of the black box device does not receive the signal;
an alert device activatable by the relay when the relay is energized; and
a non-metallic communication cable for passing the signal from the output pin of the black box device to the input pin of the black box device, the non-metallic communication cable being bound to the protected section of the grounding assembly;
wherein separation of the protected section from the grounding assembly damages the non-metallic communication cable, such that the signal does not reach the input pin of the black box device and the relay is triggered.

18. The alert system of claim 17, the black box device being a converter for converting a binary data signal to an optical fiber signal.

19. The alert system of claim 17, the non-metallic communication cable being a fiber optic cable.

20. The alert system of claim 17, the non-metallic communication cable being threaded through one or more apertures defined by the protected component of the grounding assembly.
